(19) United States
(12) Patent Application Publication
(10) Pub. No.: US 2024/0075700 A1
(43) Pub. Date: Mar. 7, 2024

(54) DEVICE AND METHOD FOR BARCODE ENGRAVING ON DIFFERENT HYDRAULIC COUPLINGS, WITH AUTOMATIC POSITIONING FOR COUNTING, ENGRAVING AND PACKAGING PARTS

(71) Applicant: DOMINIK COMERCIO E INDUSTRIA DE METAIS E EQUIPAMENTOS LTDA, São José (BR)

(72) Inventor: Cristiano REITZ, Florianópolis (BR)

(73) Assignee: DOMINIK COMERCIO E INDUSTRIA DE METAIS E EQUIPAMENTOS LTDA, São José (BR)

(21) Appl. No.: 18/448,403

(22) Filed: Aug. 11, 2023

Related U.S. Application Data
(63) Continuation of application No. PCT/BR2021/050135, filed on Apr. 1, 2021.

(30) Foreign Application Priority Data
Feb. 12, 2021 (BR) 102021002718-5

(51) Int. Cl. B29D 23/00; B65B 35/10; B65B 61/02; B65B 65/08

(52) U.S. Cl. CPC B29D 23/006; B29D 23/008; B65B 35/10; B65B 61/025; B65B 65/08; B29K 2027/06

(57) ABSTRACT

An equipment for positioning, stamping barcodes and packing separate hydraulic connections includes two conveyor belts interconnected, a receiver consisting of an inclined tray coupled to the conveyor belts that directs parts to a longitudinal positioner, which contains gutters that direct the parts to a set of helical rollers equipped with helical gears that rotate in opposite directions; a pair of sensors, a first sensor of contact with the part and a sensor after to prevent back up when tipping; a reducer guide with automatic mechanism controlled by a pneumatic cylinder; pneumatic tippers for determining which side the part should tip over; bulkheads, which allow the parts to first hit an upper bulkhead; a motor shaft connected to a side guide that restricts the positioning; a laser or ink-jet equipment for stamping a production and traceability information; and a packaging machine that prints a traceability code of parts package.

### CROSS-REFERENCE TO RELATED APPLICATIONS

This application is a continuation of International Application No. PCT/BR2021/050135, filed on Apr. 1, 2021, which claims priority to Brazilian Patent Application No. 102021002718-5, filed on Feb. 12, 2021. All of the aforementioned applications are incorporated herein by reference in their entireties.

### TECHNICAL FIELD

In general, this application belongs to the pipe and connection production sector, and refers, more specifically, to equipment and the transporting method of parts to be positioned, stamped and packaged, with the parts being collected directly from the injector extraction module, positioning each item autonomously for counting and stamping the barcode, without human intervention, after selecting the connection model in the equipment's HMI, with the delivered items packaged and labeled at the end of the process.

### BACKGROUND

The PVC pipe and fittings sector is characterized by belonging to the group of non-traditional or dynamic companies. This type of company, according to Ferraz et al. (1997), incorporates significant technological density in its processes, being those more recent in the industrial organization, which are characterized by incorporating great technological density or, for being a source of technical progress for other industries, through the supply of equipment or strategic inputs of superior technological content. It is of great importance for companies in this sector to assess the intensity with which the determining forces of competition present themselves structurally, so that they can recognize strategic alternatives capable of ensuring their maintenance in the market, with significant profitability.

The pipe and connection industry is characterized by the intensive use of PVC as a basic raw material, which is supplemented with other inputs, usually chemical additives, for the operationalization of production. The sector has undergone gradual changes in several aspects, among which the commitment to the quality of products and services provided to meet consumer requirements.

As can be seen in the sector, there is a concern with the automation of packaging and marking steps (both labels on packaging and marking on the product itself), steps considered expensive for the production process of pipes and connections in general. Chinese patent documents CN208930666 and CN108943639 are examples of this concern. Although these are processes aimed at PVC pipes, and not exactly the connections, it can be noted that there is an interest in automating the marking of the product. In these cases, the process is done shortly after the product is removed from the extruder.

Most of the solutions found use equipment commonly used in production lines, with specific adaptations to achieve the proposed objectives. Patent documents CN210192034 and CN110282206, for example, present the complete process for marking and packaging connections. Patent document CN108296183 also presents similar solutions to achieve the same objective, but with a unique identification system and the option to return suboptimal parts.

Patent documents CN208775914 and CN204184898 present specific solutions that can be incorporated into the automation of production steps. These are solutions applied on conveyors for the vertical and horizontal transport of pipes.

The current systems available have a great need for mechanical adjustments, which are manually done by operators, resulting in high configuration times and high possibility of errors.

With an automatic system, stops are eliminated for adjustments and stamping errors by positioning parts, and transportation and storage time is eliminated until the items are properly marked and packaged for shipment.

### SUMMARY

In view of the problems of prior art not yet solved with regard to the automation of the production line, this application reveals equipment and the transporting method of parts to be counted, stamped and packaged, with the connection parts being collected directly from the injector extraction module, in which the parts were manufactured, positioning each item properly and autonomously for counting and stamping the barcode, without human intervention, after selecting the connection model in the equipment's HMI. With the items being delivered, packaged and labeled at the end of the process.

The equipment is used to stamp the barcode, manufacture date and lot, for tracking purposes throughout the life of the parts, performed after the injection step of the items. The equipment has as a distinct feature, its automatic positioning system along with the stamping and packaging modules. Where problems with storage and transport time to other sectors of the manufacturing area are eliminated. As it is impossible to stamp and package immediately after the injection step, logistics is necessary that involves the transport and storage of these parts until they have the barcode stamped on and are subsequently packaged, with these processes being carried out basically using manual equipment and in separate steps. This causes the need for a long wait time between injection and packaging. With the equipment having these functions integrated and automated, this period can be reduced from days to minutes, without the need to store the parts that have not been stamped or packaged.

### BRIEF DESCRIPTION OF THE DRAWINGS

For this application to be fully understood and carried out by any technician in this technological sector, it will be described in a clear, concise and sufficient manner, based on the attached drawings that illustrate and support it listed below:

FIG. 1 depicts a perspective view of an equipment with a first conveyor receiving injector parts;

FIG. 2 depicts a perspective view of external conveyors of the equipment, highlighting a second conveyor that receives the parts and transports them to a receiver;

FIG. 3 depicts a perspective view of the receiver directing the parts to a positioner;

FIG. 4 depicts a perspective view of a longitudinal positioner with rollers receiving the parts that are deposited on rollers;

FIG. 5 depicts a rear perspective view of the longitudinal positioner with rollers acting in opposite directions, forcing the parts to rotate on their axis until they are in a longitudinal position for a third conveyor;

FIG. 6 depicts a side view of the equipment with the third conveyor carrying the parts that will be turned by rotating tippers;

FIG. 7 depicts a top view of the equipment showing the flow of the parts that return to the start of the cycle;

FIG. 8 depicts a left side view of the equipment, highlighting the assembly of conveyors and components that receive the parts from the longitudinal positioner;

FIG. 9 depicts a perspective view of the operation of a reduction guide, highlighting an activation of a pneumatic cylinder that moves the guide;

FIG. 10 depicts a front view of the assembly of the cylinder set of a part tipping system;

FIG. 11 depicts a front view of a roller system at two different height levels, being determined by a pair of vertically mounted pneumatic cylinders;

FIG. 12 depicts a front view of a tipping selection, with two tipping directions selected with activation of a horizontally mounted pneumatic cylinder;

FIG. 13 depicts a side view of positioning possibilities for a Te connection after step 3;

FIG. 14 depicts a front view of a tipped part in step 4 on the left, and of a smaller base part facing down to the right that will be tripped in step 5;

FIG. 15 depicts a front view of an inactive and functioning part tipping system;

FIG. 16 depicts the a positioning and stamping cycle by a part model in step 6, with emphasis on piping elbows that have been tipped correctly and slide freely through a turning mechanism;

FIG. 17 depicts the positioning and stamping cycle by the part model in step 6, with emphasis on the piping elbows that have been tipped correctly, requiring a 180° turn through the rotation mechanism;

FIG. 18 depicts a top view with a division of the 9 part positioning steps;

FIG. 19 depicts a top view of the equipment;

FIG. 20 depicts a sectional view of the equipment;

FIG. 21 depicts a perspective view of the equipment, with emphasis on the stamp area;

FIG. 22 depicts a positioning and stamping cycle by the part model, with emphasis on Te connections with 20 to 110 gauge;

FIG. 23 depicts the positioning and stamping cycle by the part model, with emphasis on the piping elbows with 20 to 110 gauge;

FIG. 24 depicts the positioning and stamping cycle by the part model, with emphasis on weldable sleeves with 20 to 110 gauge;

FIG. 25 depicts the positioning and stamping cycle by the part model, with emphasis on reducer connections;

FIG. 26 depicts the positioning and stamping cycle by the part model, highlighting the inclined reducer connections when passing through the junction of the conveyors; and

FIG. 27 depicts the positioning and stamping cycle by part model, highlighting reducer connections and illustrating an operation of a reducer guide, which limits a movement of the reducer when it is passing over a joint between conveyors to prevent the reducer from being in any position illustrated in FIG. 26.

### DETAILED DESCRIPTION OF THE EMBODIMENTS

This application discloses technology that automatically positions plastic, aluminum or other material connections that can be counted and receive barcode printing/stamping, without this material damaging the components of the equipment due to weight, dimension, or inadequate chemical composition of the items.

First, the parts 6 are taken to the positioning system, by two conveyor belts 1, 2, the first receives the parts 6 directly from the injector and takes them to the second conveyor 2, with continuous or intermittent movement, according to the needs of each connection model. The intermittent mode is responsible for supplying the system in a more cadenced manner, preventing a large volume of parts 6 from reaching the system at the same time, preventing back ups due to a disoriented increase in the flow of parts. The parameters of the conveyor, both continuous and intermittent, are available in the part requirements and may have their values changed for different models. Then the parts are delivered to the conveyor belt 2, which is responsible for vertically transporting the parts and supplying the positioning system.

The conveyor belts 1, 2 external to the equipment have a programmable speed adjustment and an intermittent mode available, where it is possible to determine the time where each conveyor belt is turned on and off separately, as already discussed.

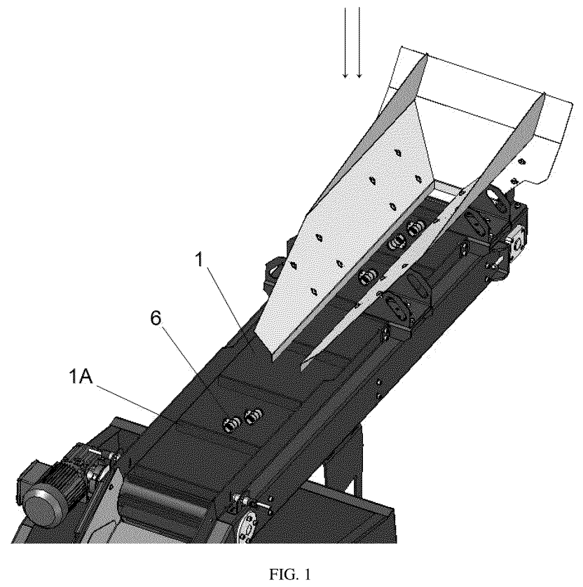

According to FIG. 1, the items to be stamped and packaged are collected directly from the injector that manufactured them, starting the process soon after leaving the injection mold, which fall onto the first conveyor using gravity.

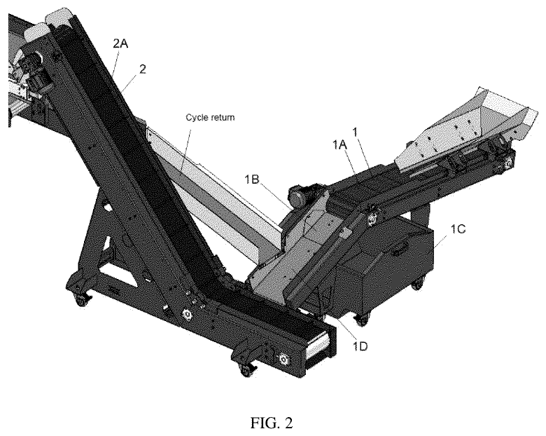

The conveyor 1 is constructed based on a strap equipped with rubber strips 1A, pulled by a geared motor and driven with a frequency inverter. Its structure is made of steel and rolling shafts. And it is responsible for collecting the parts of the injector and transporting them horizontally to the conveyor 2, as shown in FIG. 2. The conveyor belt 1 uses strips 1A to lift the parts 6 up to a gate system that opens to accumulate the parts in a reservoir 1C, when the equipment has an emergency situation, which forces it to stop the operation. In normal operation, the gate 1B is closed and the parts slide on a slide 1D to the conveyor 2.

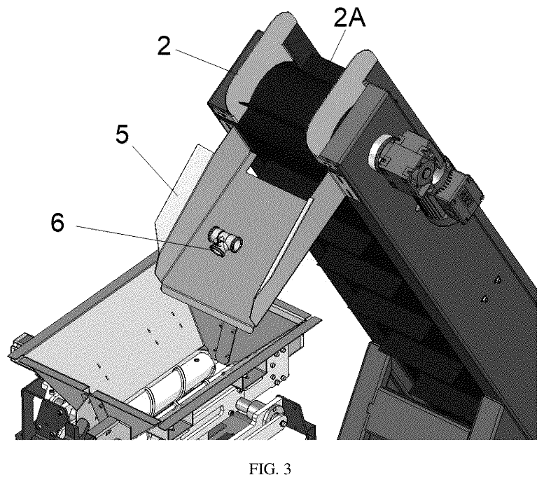

The conveyor belt 2 is constructed using the same principles as the conveyor belt 1, containing rubber strips 2A welded to the rubber belt, as it is responsible for vertically transporting the parts to the receiver 5 as shown in FIG. 3.

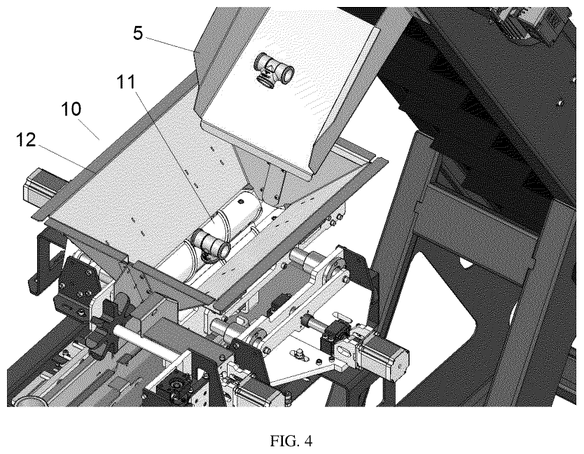

The receiver 5 consists of an inclined tray coupled to the conveyor 2 and is responsible for directing the parts to the longitudinal positioner 10, which contains gutters 12 that direct the parts 6 to the helical roller set 11 equipped with helical gears that rotate in opposite directions, aligning the parts 6 in the longitudinal direction to the conveyor 3, as shown in FIG. 4. Optionally, the receiver 5 can be replaced by a meter coupled to an electromagnetic vibrator that provides continuous and controlled movement, causing the parts to fall in a controlled amount; responsible for preventing simultaneous parts from entering 6 into the longitudinal positioner 10.

Step 1

In the first step, the parts 6 are delivered by the conveyor belt 2 falling by gravity onto the gutters 12 that prevent them from falling out of the mechanism and direct them to the helical rollers 11. The distance between the rollers delimits the measurement of the gauge of the items so that only the parts 6 that have their largest dimension in the direction of movement of the conveyor can fall onto the conveyor 3.

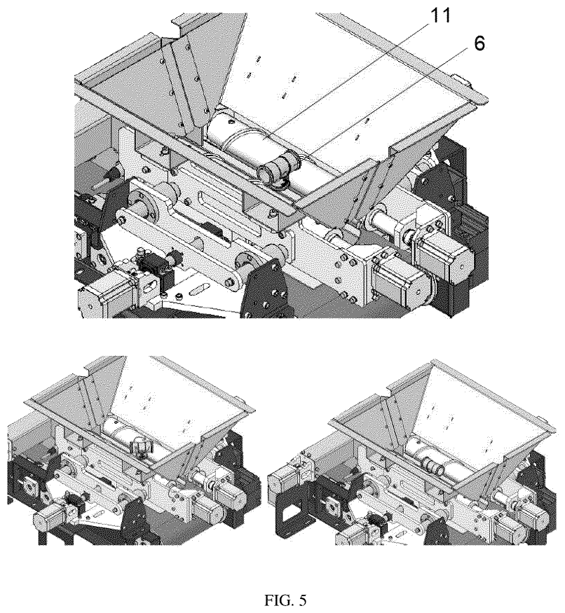

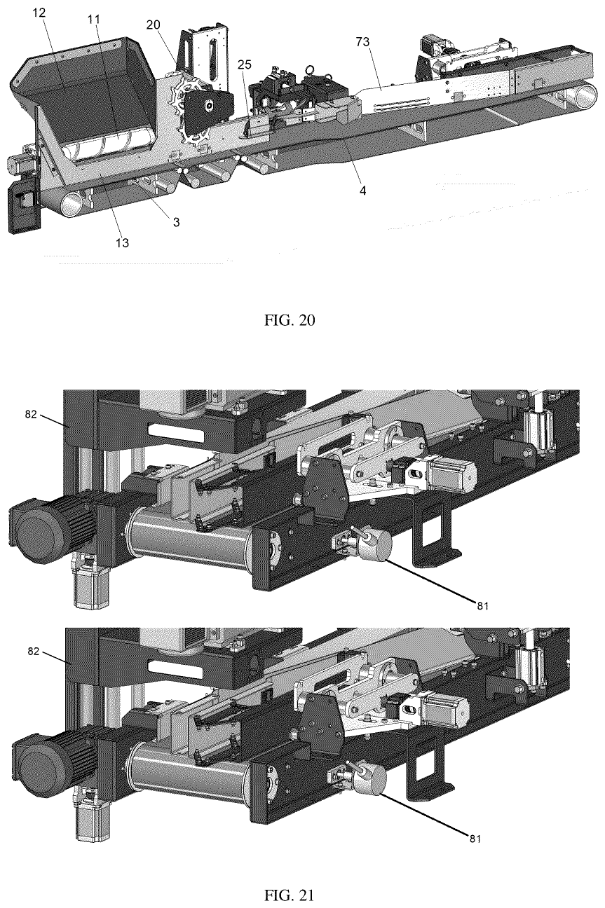

According to FIG. 5, the rollers 11 act in opposite directions forcing the parts 6 to rotate on their axis until the conveyor belt 3 is in the longitudinal position, falling by gravity onto the conveyor 3 and having its lateral movement eliminated by two lateral limiters 13 shown in FIG. 20. The helical rollers 11 are made of polymeric material and driven by stepper motors with constant speed within the process. This roller system, 11 along with the lateral limiters 13, has a linear movement mechanism for each side of the conveyor 3, being adjusted according to the gauge of the parts 6 being worked on. Its movement is determined by electronic control and driven by stepper motors and trapezoidal spindles.

Once on the conveyor belt 3, the parts 6 have their degrees of freedom almost entirely annulled, with only three possibilities depending on the connection model.

Step 2

In this step, there are rotary tippers 20 that turn the parts 6 that are consonant with the delimited height on the conveyor, 3 when necessary. The height is determined according to the shape of each part, allowing only properly laid parts to pass through, which eliminates one to two possibilities of positions depending on each model.

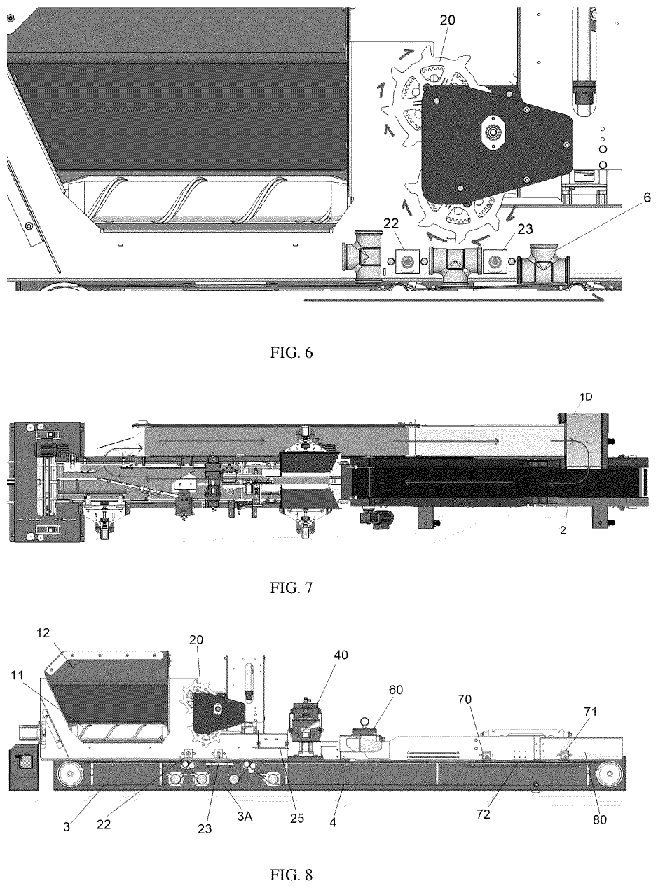

The conveyor 3 is constructed on the basis of a strap equipped with rubber splints 1A, pulled by a geared motor and driven with a frequency inverter. It is responsible for transporting the parts 6 to the rotating tippers 20 to position the parts, as shown in FIG. 6, where a part that has been positioned is demonstrated, and another in the vertical position that will need to be repositioned.

Another possible position for the part is eliminated 6 by means of the tippers 20 equipped with rods 21 on the cardinal and collateral axes that touch the parts 6 at their upper end, causing them to rotate against the movement of the conveyor 3, forcing them to be positioned horizontally, which will be the only possibility for the parts 6 to continue on the conveyor 3. The rotary tippers 20 are driven by a stepper motor with constant speed and have the height determined in the electronic control of the equipment, with the height variation being carried out by a lifting mechanism with stepper motor and spindle with trapezoidal thread. Preferably, two tippers 20 are used instead of one, allowing the parts that are thrown upwards to eventually return to the longitudinal positioner 10; with one tipper 20 only and some parts may move over it.

This mechanism has a pair of sensors 22,23, a first contact 22 sensor with the part and a sensor 23 after, and together with the reversible conveyor 3A, enable the function of protecting against back ups when tipping. In normal operation, the part 6 passes through the first sensor 22 before the tippers 20 and after being turned, will pass in front of the second sensor 23 after a short known time interval, which is given by the ratio of the distance between the sensors 22,23 and the speed of the conveyor 3. Each part 6 will have a specific time to be positioned in addition to the time of passage through the sensors 22,23. When the system verifies that the part 6 has already reached the first sensor 22 and a longer time than specified for the model is reached, without the second sensor 23 being activated, the control understands that there was a back up in the tipping procedure. Therefore, the rotation of the conveyor belt 1 is reversed, freeing up space to allow the correct positioning of the part 6 and unclogging the system that returns to normal operation. The time limit for this passage between one sensor and another is configurable according to the need and saved for each part model. When this procedure that prevents the back up of parts is performed a few times without success (number of times specified in the model requirements), the equipment enters the part extraction mode that can be called “Cleaning 1”.

The cleaning mode in question is responsible for removing all the parts 6 that are on the conveyor 3 and expelling them so that they return to the input conveyor 1, returning to the cycle as shown in FIG. 7. The procedure consists of opening the lateral bulkheads 13, raising the tippers 20, to release the parts 6 that are stuck, connecting the conveyor 3 and the air nozzle 72 to remove them from the system and return to the start of the cycle on the conveyor 3 until there are no parts 6 obstructing the operation of the process.

Step 3

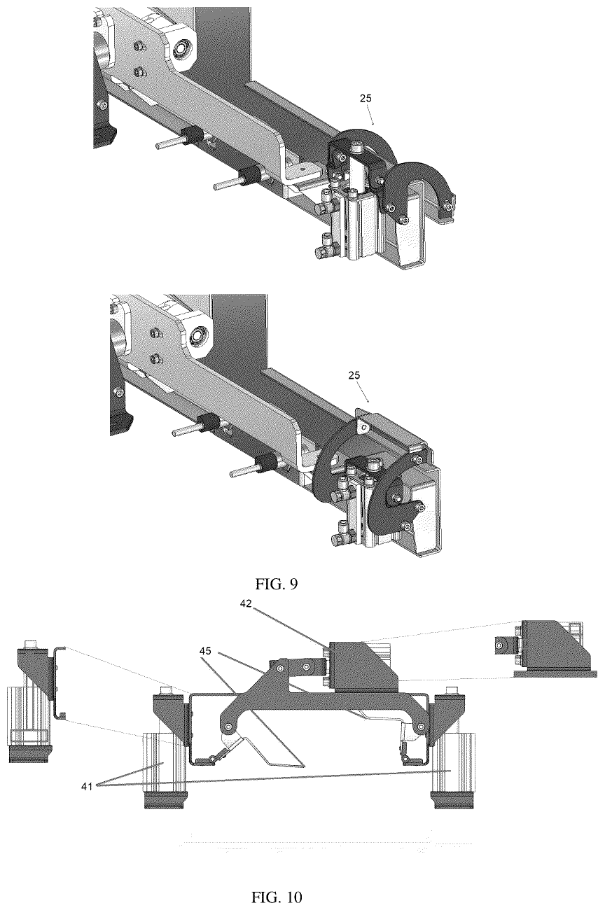

In this step, there is the division between the conveyors 3 and 4 of the positioner, necessary to create a separation between the parts 6, avoiding the error in the reading of the number of parts and also in the start stamping signal. For the reducer parts, it has a guide 25 with an automatic mechanism, by means of a pneumatic cylinder 30 that when lowering removes it from the path, being activated in the preset of the equipment, as shown in FIG. 9.

Step 4

On the conveyor, 4 there are position sensors (not shown) to determine which side the part 6 should tip over by means of the pneumatic tippers 40. Each tipper 40 is based on a set of double-acting cylinders 41,42 driven with a double-solenoid valve, as shown in FIG. 10.

In this step, a system with a pneumatic tipper 40 is presented where two movements are performed: the height is adjusted and the side of the fin is selected, 45 which is responsible for guiding the part 6 so that it falls to its opposite side.

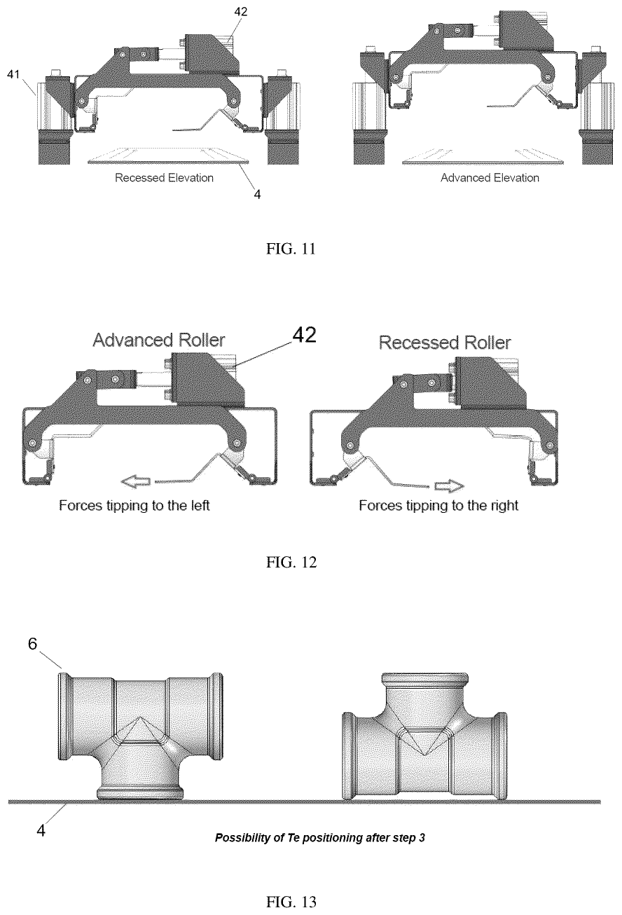

As illustrated in FIG. 11, the height adjustment movement is done by the pneumatic cylinders 41 to determine which gauge of the parts will be used by having the fins 45 work at the correct height to perform lateral tipping. This adjustment is made on the part preset.

According to FIG. 12, the selection of which side the part 6 should tip over is made by alternating which side the fin 45 of the flipper will be used making the controlled obstruction of the path where the part passes through the fin, forcing it to tip laterally in the opposite direction to that of the selected fin. This selection is made by means of a horizontally mounted pneumatic cylinder 42, and its stroke limits are used for the system to recognize which position is selected of the fins.

This mechanism is used for Te and Elbow connections. For other models of parts, the mechanism is raised (shown in FIG. 11 on the right) so that the parts move freely under the system, without any interaction with the objects, since it is not necessary to use.

For the Te, the mechanism is selected in the preset, and active movement is not necessary.

Step 5

As shown in FIGS. 13 to 15, in this step there is a passive tipping system for the Te connections, where a mechanism is presented so that it is placed or removed from the route with the pneumatic tipper 40.

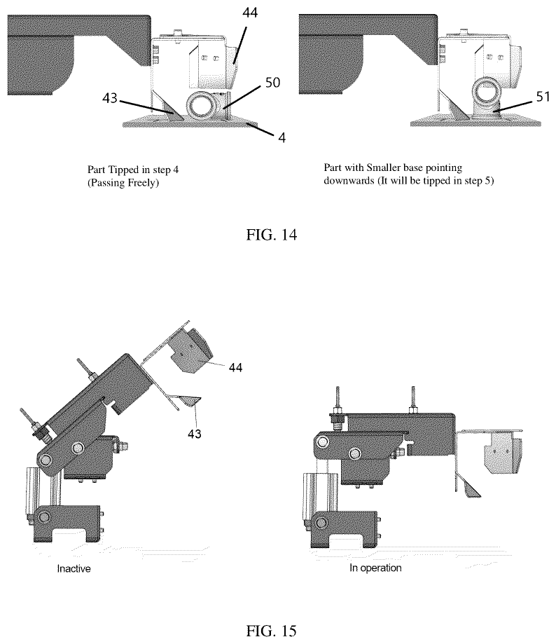

The passive tipping system works as follows: the conveyor belt 3 transports the parts through the rotating tippers 20 of Step 3, where there are two possible positions 50,51 for this part model. In Step 4, parts 6 with the larger base 51 facing downwards are tipped to the right as shown in FIG. 14 on the right; the others pass freely 50, as shown in FIG. 14 on the left. The system works using the inertia and friction that the conveyor belt 4 provides to the part 6, along with the bulkheads. When the part 6 reaches the bulkheads 43, 44, it suffers a sudden brake, causing it to rotate guided by them, remaining in the desired position.

In summary, the part that will be as the part on the right side of FIG. 14 is turned in the tipper of Step 5, being in the position equal to the part on the left side of FIG. 14 once positioned in Step 4, which pass directly through the bulkhead 44 without any interference. The part from Step 4 that is positioned 51 similar to the part to the right of FIG. 14, enters the bulkhead equal to the depiction of FIG. 13. When it enters the bulkhead, it will first hit the upper bulkhead 44, which will cause it to be thrown to the left by the lower bulkhead 43 to rotate it and tip it sideways, as in the position 50.

The mechanism will be modified to be manually fitted to a pneumatic base, which raises or not the bulkheads, which will be manually changed in the machine preset, as shown in FIG. 15. And it should be noted that it works similarly for Te 50 mm and Te 25 mm parts, according to configuration adjustments.

Step 6

In this step, there is a passive rotation system 60 exclusive to the elbow and 90° curve. All elbows and curves are tipped to the same side in Step 4, requiring a 180° turn in the parts depending on the position they are in.

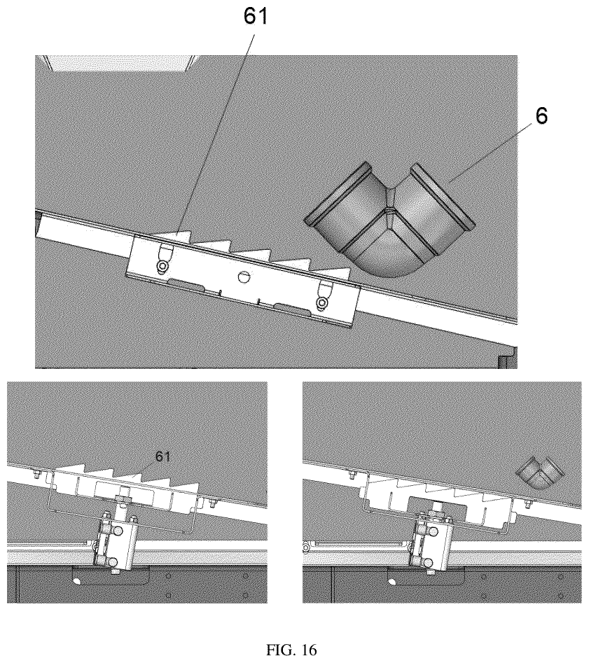

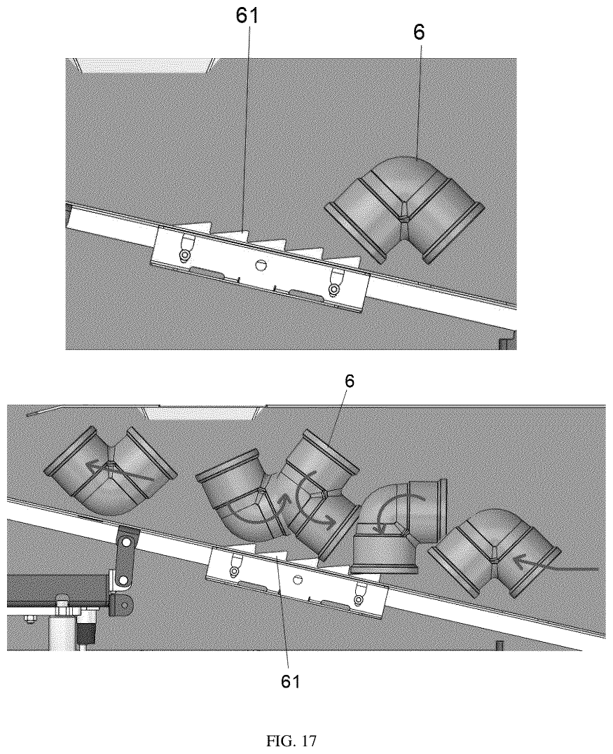

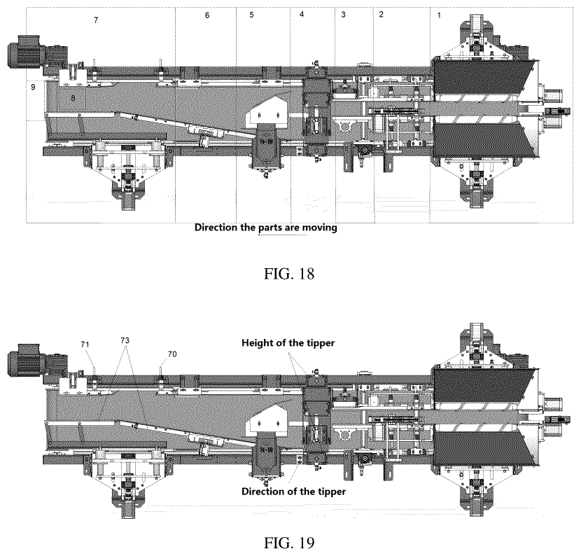

This system has a specific shape so that the parts that are in the desired position, slide through the system and continue on until they are stamped without modifying their position as shown in FIG. 16. On the other hand, the parts that are opposite to the desired position as illustrated in FIG. 17, are stuck in the bulkheads 61 and the movement of the conveyor 4 forces the part to rotate 180°, all with the same position for stamping.

Step 7

In the last step before stamping, there is another pair of sensors 70,71, which will determine if the part 6 was positioned correctly, and can be removed from the line in case of positioning failure through an air nozzle 72, where the part returns to the start of the cycle.

In this step, a motorized linear shaft connected to a lateral guide 73 is provided as shown in FIG. 20. The assembly forms a restriction on positioning, forcing the parts 6 to align in the direction of the length of the conveyor 4. This results in a minimal variation of the position of the parts in relation to the stamping area 80.

This lateral guide 73 contains two sensors 70,71 used for checking parts. The first sensor 70 to be activated is responsible for measuring the part and verifying that it is in the correct position. An air blow is used to remove this part in the cycle as already addressed, if it is not positioned correctly. The rejected part goes back to the start of the cycle. The second sensor 71 is used to send the laser the stamping order and also the part count.

By interconnecting the readings between the sensors 70,71, it can be verified whether the part 6 actually reached the stamping area 80, or got stuck in the path between the air nozzle 72 and the stamping area 80, if the expected time for the passage of the part 6 between the sensors 70,71 is exceeded. In this case, the equipment enters the “Cleaning 2” mode, in which all systems of the equipment are stopped, followed by the opening of the gauge of Step 7. After the gauge is opened, the exit conveyor 4 is reversed with the air nozzle 72 switched on for a predetermined time, which has its direction changed again to the normal exit direction still with the nozzle 72 activated for another period of time.

As a result, the part(s) that are stuck in the system are removed from the process. All parameters are saved by part models and can be modified according to the needs of each model. After this procedure, the gauge measurement is adjusted again and finally returns to the automatic cycle.

Step 8

The stamping step 80 of the production and traceability information is performed by laser or ink-jet equipment. Parts are properly stamped and accounted for in the system.

In the laser stamper, there is a stamping area, which can be from 100×100 mm to 300×300 mm, depending on the focus lens used. Within this area, it is possible to position the code stamp in any location electronically, without the need for mechanical movement.

For the Ink-jet stamper, the fixed stamp is positioned, requiring an auxiliary horizontal axis, for the correct positioning of the stamping head in relation to the trajectory of the part on the conveyor.

In the use of both the laser and the ink-jet, it is necessary to compensate the height of the stamper in relation to the part 6, since both systems depend on a fixed distance between the stamping head and the part. This compensation is required due to equipment processing parts from different stamping heights. Which is compensated with a linear axis 82 mounted vertically, driven with stepper motors and referenced from the conveyor height.

It is stamped while the part is in motion, with this travel speed informed to the stamper by means of an encoder 81 coupled directly to the conveyor.

Step 9

The items are packaged after they are stamped, where the conveyor 4 deposits the parts 6 inside the pre-formed package, being closed when the number of parts per package is reached, which will be positioned for collection.

In the formation of the package, the packaging machine 90 prints the traceability code on it, so that they are correctly forwarded to the storage and shipping processes.

In short, with the parts delivered to the system, they are mechanically positioned by means of fins, accessories molded by part model and varied sensors, all integrated into the logical control of the equipment to ensure the correct positioning of the parts. This is then subdivided into steps, as shown in FIG. 14, where each step is responsible for performing a movement, where at the end the part is correctly positioned for the barcode to be stamped and subsequent packaging.

The conveyor 3 is responsible for advancing and reversing in the direction of movement to correct the possible back up of parts 6 in the tipper system 20. Its speed is approximately 80% of the conveyor 3A and its drive is independent, being able to adjust the speed of the conveyor according to the need.

The conveyor 3A has a fixed direction of movement and its speed is approximately 55% of the conveyor 4. The two conveyors 3A,4 are mechanically coupled by means of gears. This difference in speed occurs so that when the parts are directed to the conveyor belt 4, this mechanism creates a spacing between the parts 6 so that there is no failure in the reading of the stamping sensor or in the stamping itself.

The conveyor belt 4 transports the parts 6 through the other positioners, ending with the passage through the stamping area 80 and delivery of the parts to the packaging machine 90. Its drive is independent, being able to adjust the speed of the conveyor according to the need.

Positioning and Stamping Cycle by Part Model

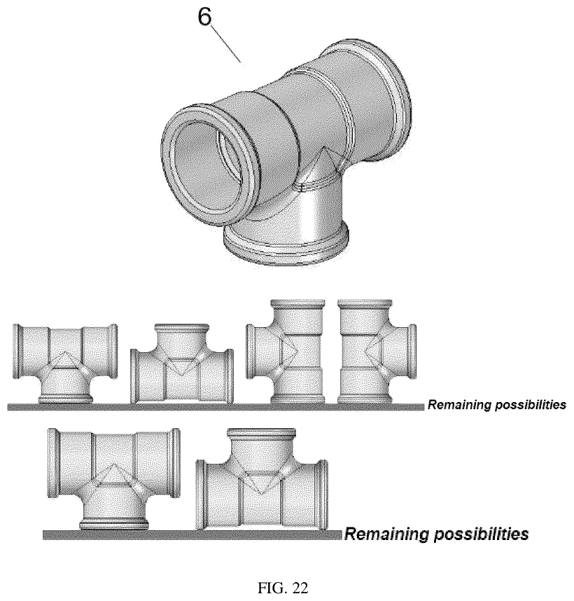

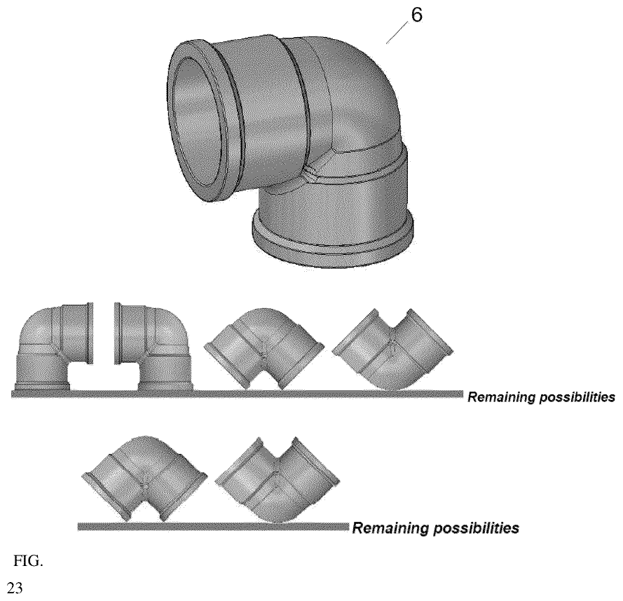

According to the sequence shown in FIG. 22, the Te parts reach Step 1 of the positioner 10 without a defined position. When passing through the helical rollers 11, they are oriented to stay with their length in the same direction of the movement of the conveyor 3, leaving four possibilities of positions. When passing through the tippers 20, the parts that have their longest length vertically are repositioned in the step 2, leaving two possibilities. The parts move away from each other as they move from one conveyor belt to another in Step 3. In Step 4, the parts that have their largest base facing downwards are tipped sideways to the right; the others are slightly deflected and continue to Step 5, being tipped in the same position as the other parts, being aligned on the same axis to be stamped in Step 8.

According to the sequence shown in FIG. 23, the elbow parts reach Step 1 of the positioner 10 without a defined position. When passing through the helical rollers 11, they are oriented to stay with their length in the same direction of the movement of the conveyor, leaving four possibilities of positions. When passing through the tippers 20, the parts 6 that have their longest length vertically are repositioned in Step 2, leaving two possibilities. The parts 6 move away from each other as they move from one conveyor belt to another in Step 3. Its size is measured by the sensor corresponding to its gauge, which is positioned in Step 3, allowing the system to know the position of the part. In Step 4, the roller system is actuated depending on the value measured by the sensor of the previous step. Remaining in position so that the part 6 falls to the correct side when passing through the mechanism. When they reach Step 6, they are aligned on the same axis to be stamped in Step 8.

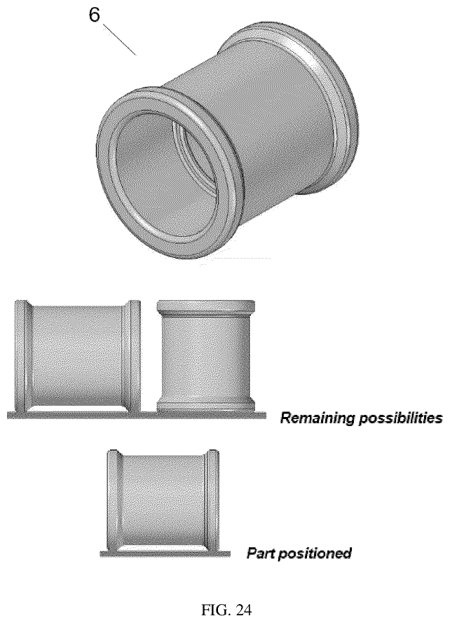

According to the sequence shown in FIG. 24, the weldable sleeve parts reach Step 1 of the positioner 10 without a defined position. When passing through the helical rollers 11, they are oriented to stay with their length in the same direction of the movement of the conveyor 3, leaving two possibilities of positions. When passing through the tippers 20, the parts 6 that have their longest length vertically are repositioned in Step 2. They are positioned and only need to be transported in Step 7. The parts move away from each other as they move from one conveyor belt to another in Step 3. In Step 4, the roller system 40 is in a working position for 50 mm parts, so that the parts 6 can pass through without interference under the mechanism, as in Step 5. When they reach Step 7, they are already aligned on the same axis to be stamped in Step 8.

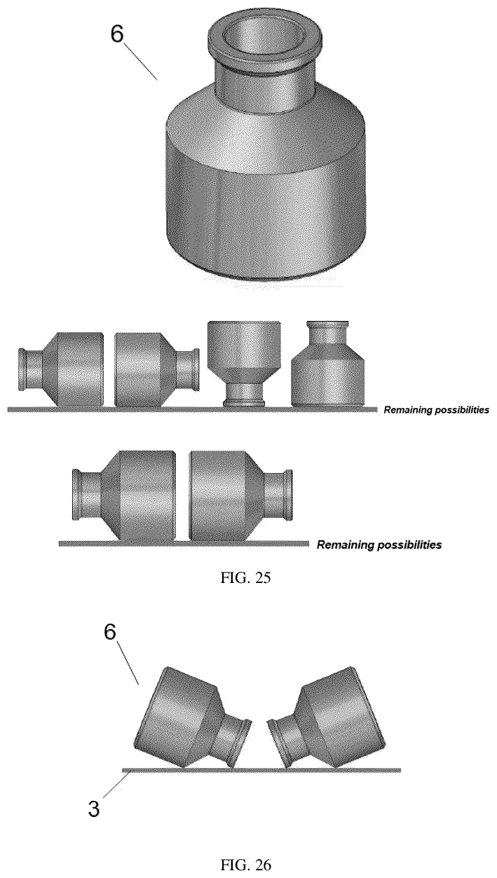

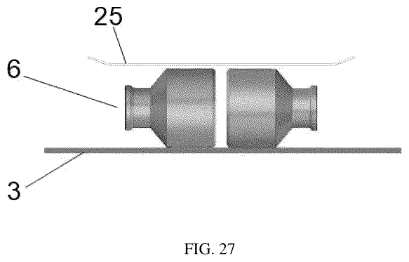

According to the sequence shown in FIG. 25, the reducer parts reach Step 1 of the positioner 10 without a defined position. When passing through the helical rollers 11, they are oriented to stay with their length in the same direction of the movement of the conveyor 3, leaving four possibilities of positions. When passing through the tippers 20, the parts 6 that have their longest length vertically are repositioned in Step 2. This particular model has a particularity. As shown in FIG. 26, when passing through the junction between the conveyors 2 and 3 in Step 3, an unwanted movement of the part 6 may occur because its center of mass is displaced from the support base, being inclined in relation to the conveyor. To avoid this movement, as shown in FIG. 27, an upper guide 25 installed on the junction of the conveyors is used and 3, so that there is not enough space for the part 6 to lean to a point of no return, forcing it to return to the flat base in relation to the conveyor belt 3 when passing through the junction. The parts 6 move away from each other as they move from one conveyor belt to another in Step 3. In step 4, the roller system 40 is in a working position for 50 mm parts, so that the parts can pass through without interference under the mechanism. They reach Step 7 already aligned on the same axis to be stamped in

Step 8. Even arriving with two position possibilities in the stamping step 80, this does not affect the stamping, since the sensor takes the reading in the lowest position of the part, dispersing the bottleneck of the part in this case.

It is important to emphasize that the figures and description made do not have the ability to limit the forms of execution of the inventive concept proposed herein, but rather to illustrate and help explain the conceptual innovations revealed in this solution. Thus, the descriptions and images must be interpreted in an illustrative and non-limiting manner, and there may be other equivalent or analogous ways of implementing the inventive concept disclosed herein and that do not escape the spectrum of protection outlined in the proposed solution.

1. An equipment for stamping barcodes on separate hydraulic connections, with automated positioning for counting, stamping and packaging parts, comprising two conveyor belts interconnected, a receiver consisting of an inclined tray coupled to the conveyor belts that directs parts to a longitudinal positioner, which contains gutters that direct the parts to a set of helical rollers equipped with helical gears that rotate in opposite directions;
wherein the rollers move in opposite directions forcing the parts to rotate on their axis and having their lateral movement limited by two lateral limiters; a conveyor is constructed on a base with rubber straps that has motorization similar to the conveyor belts, and transports the parts to two rotary tippers, preferably equipped with rods on cardinal and collateral axes that touch the parts at their upper end;
a pair of sensors, a first sensor of contact with the part and a sensor after to prevent back up when tipping; on the conveyor belt position sensors are provided to determine which side the part should tip over by means of pneumatic tippers, each tipper being based on a set of double-acting cylinders driven with a double-solenoid valve;
a reducer guide with automatic mechanism controlled by a pneumatic cylinder, configured in the preset; the pneumatic tippers present height adjustment and selection of fin side, a height adjustment movement being made through the pneumatic cylinder to determine which gauge of the parts will be used by placing fins to work at a correct height to perform the lateral tipping, adjusted in the preset;
the selection of which side of the part must tip is made by alternating which side the fin of the tippers will be used by making a controlled obstruction of a path where the part passes through the fin, selected by means of the pneumatic cylinder mounted horizontally, and its stroke limits are used for a system to recognize a selected position of the fins;
bulkheads, which allow the parts to first hit an upper bulkhead, which will cause it to be thrown to the left by a lower bulkhead to rotate and tip it laterally; passive turning system formed by bulkheads and the movement of the conveyor belt that forces the part to rotate 180°, all with the same positioning for stamping;
a pair of sensors, which determine whether the part has been positioned correctly, and can be removed from a line in case of failure in positioning by means of an air nozzle, where the part goes back to the start of a cycle;
a motor shaft connected to a side guide that restricts the positioning, forcing the parts to align in the direction of the length of a conveyor; stamping of a production and traceability information by a laser or inkjet equipment; and packaging machine that prints the traceability code in the formation of a parts package.

2. The equipment according to claim 1, wherein the conveyor belts external to the equipment have programmable speed adjustment and an intermittent mode, which determines the time each conveyor belt is turned on and off separately.

3. The equipment according to claim 1, wherein the conveyor belt is constructed based on a belt equipped with rubber strips, pulled by a geared motor and drive with frequency inverter, and the structure of the conveyor belt is made of steel and rolling shafts; and the conveyor belt is composed of a reservoir positioned below a gate, interconnected to the slide coupled to the conveyor belt.

4. The equipment according to claim 1, wherein the conveyor belt is constructed based on a belt equipped with a smooth rubber strap, pulled by a geared motor and drive with frequency inverter, and the structure of the conveyor belt is made of steel and rolling shafts; and also contain rubber strips welded to a rubber band.

5. The equipment according to claim 1, wherein the receiver is replaced by a meter coupled to an electromagnetic vibrator that provides a continuous and controlled movement.

6. The equipment according to claim 1, wherein the helical rollers to be constructed of polymeric material and driven by stepper motors with constant speed; and the rollers along with the lateral limiters, have linear movement mechanism for each side of the conveyor, being adjusted according to the gauge of the parts; and their movement to be determined by electronic control and driven by stepper motors and trapezoidal spindles.

7. The equipment according to claim 1, wherein the rotating tippers are driven by a stepper motor with constant speed and have the height determined in a electronic control, with a height variation being performed by a lifting mechanism with the stepper motor and a spindle with trapezoidal thread.

8. The equipment according to claim 1, wherein the laser stamper has a stamping area, which can be from 100×100 mm up to 300×300 mm, depending on focus lens.

9. The equipment according to claim 1, wherein an Ink-jet stamper, have the positioning of a fixed stamping, requiring an auxiliary horizontal axis, for a correct positioning of a stamping head in relation to the trajectory of the part on the conveyor.

10. The equipment according to claim 1, wherein the use of the laser as an ink-jet requires compensation of the height of a stamper in relation to the part, by means of a linear axis mounted vertically, driven with stepper motors and referenced from the height of the conveyor.

11. The equipment according to claim 1, wherein the equipment is stamped with the part in motion, having this travel speed informed to a stamper by means of an encoder directly coupled to the conveyor.

12. A method for stamping barcodes on separate hydraulic connections, with automated positioning for counting, stamping and packaging parts, comprising following steps:
a) moving the parts to a positioning system by conveyor belts, where a first belt receives them directly from an injector by gravity and takes them to a second belt;
b) delivering the parts by a conveyor, by gravity, to gutters which direct them to helical rollers;
c) acting the rollers in opposite directions forcing the parts to rotate on their axis until they are in a longitudinal position, falling by gravity onto the conveyor;
d) transporting the parts to rotating tippers, which make them conform to a delimited height, turning them when necessary;
e) passing the parts pass through a first sensor before the tippers and after being turned, the parts pass in front of a second sensor, after a small interval of time;
f) actuating a reducer guide optionally by a pneumatic cylinder;
g) determining which side the part should tip over through the pneumatic tippers by position sensors;
h) adjusting the height and selecting a fin side guiding the part on the tippers, so that the part falls to an opposite side of the selected fin;
i) passing Te connections through a passive tipping system, where a mechanism is presented to be placed or removed from a route with tippers;
j) passing elbows and 90° curves through a passive turning system turning the parts 180° depending on the position they are in;
k) determining whether the part has been positioned correctly by a pair of sensor and the part can be removed from the line in the event of a positioning failure by the air nozzle, where the part returns to the start of the cycle;
l) performing the stamping of the production and traceability information by a laser or inkjet equipment, and the parts to be stamped and accounted for; and
m) packaging items after they are stamped, where the conveyor deposits the parts inside a preformed package, being closed when the number of parts per package is reached, which will be positioned for collection.

13. The method according to claim 12, wherein: in step a), operating the conveyor with continuous or intermittent movement, opting according to a connection model.

14. The method according to claim 12, wherein: in step d), determining the height of the tippers according to the shape of each part, only allowing a passage of parts that are properly laid, which eliminates one to two possibilities of position depending on each model.

15. The method according to claim 12, wherein: in step e), giving a time interval by the ratio of a distance between the sensors by the speed of the conveyor belt, each part will have a specific time to be positioned beyond the time of passage by the sensors.

16. The method according to claim 12, wherein: in step e), verifying that the part has already reached the first sensor and a longer time than specified for the model if it is reached, without the second sensor being activated, a control understands that there was a back up in a tipping procedure; reversing a rotation of the conveyor, freeing space to enable the correct positioning of the part and unclogging the system so that the system can return to normal operation.

17. The method according to claim 12, wherein: in step e), configurating the time limit for this passage between one sensor and another sensor according to the need and saved for each part model; and when a procedure is performed unsuccessfully, the equipment enters a “Cleaning 1” part extraction mode.

18. The method according to claim 17, wherein: in step e), removing all parts that are on the conveyor belt and expelling them so that they return to the inlet conveyor, returning to the cycle, by a cleaning mode; opening lateral bulkheads, raising the tippers to release the parts that are stuck, connecting the conveyor and the air nozzle to remove them from the system and return to the start of the cycle on the conveyor, until there are no parts obstructing the operation of the equipment.

19. The method according to claim 17, wherein: in step f), actuating the guide only for reducer parts.

20. The method according to claim 17, wherein: in step h), using the mechanism for the Te and Elbow connections; for other models of parts, the mechanism is raised so that the parts pass freely under the system, without any interaction with the parts.

21. The method according to claim 12, wherein: in step h), selecting the using sensors, being positioned according to the position in which the part is and for the Te, the mechanism is selected in the preset, not requiring active movement.

22. The method according to claim 12, wherein: in step i), transporting the parts by the rotating tippers, here there are two possibilities of positions for this part model, and the parts with a larger base facing downwards are tipped to the right and others pass freely.

23. The method according to claim 12, wherein: in step j), sticking the parts that are opposite to the desired position in bulkheads and a movement of the conveyor forces the parts to rotate 180°, all with the same positioning for stamping.

24. The method according to claim 12, wherein: in step k), measuring the part and verifying that it is in the correct position by the first sensor to be actuated; and an air blow is used to remove this part in the cycle, if the prat is not correctly positioned, whose rejected part goes back to the start of the cycle.

25. The method according to claim 12, wherein: in step k), sending a the stamping order to the laser as well as the parts count by the second sensor.

26. The method according to claim 12, wherein: in step k), interconnecting the readings between the sensors, to verify that the part reached a stamping area, or got stuck in the path between the air nozzle and the stamping area, if the expected time for a passage of the part between the sensors is exceeded.

27. The method according to claim 12, wherein: in step k), entering an equipment into a “Cleaning 2” mode, in which for all systems of the equipment, continuing with the opening of a gauge and, after the gauge is opened, reversal of an exit conveyor is made with the air nozzle turned on for a pre-determined time, which has its direction changed again to a normal direction of exit still with the nozzle actuated for another period of time.

28. The method according to claim 12, wherein: in step m), printing the traceability code on the package in the formation of the package and the package is then forwarded to the storage and shipping processes.
